(19) United States
(12) Patent Application Publication
(10) Pub. No.: US 2009/0071559 A1
(43) Pub. Date: Mar. 19, 2009

(54) WATER DIVERTER

(76) Inventor: Hao Nan PENG, Tanzih Township (TW)

Correspondence Address: EGBERT LAW OFFICES, 412 MAIN STREET, 7TH FLOOR, HOUSTON, TX, 77002, US

(21) Appl. No.: 11/855,065

(22) Filed: Sep. 13, 2007

(51) Int. Cl. F16K 11/00

(52) U.S. Cl. 137/625.46

(57) ABSTRACT

The present invention provides an improved structure of a water diverter, which includes a housing, a brake axle, a drive seat, a rotary valve, a fixed valve, a base and water inlet/water outlet. The water inlet is placed centrally onto the fixed valve and base, so that one end of the through-flow slot of rotary valve is normally linked to the water inlet. The other end is adapted to different water outlets depending upon the rotation angle of the rotary valve. The water inlet and outlet of the water diverter are incorporated into the bottom of the water diverter, and water flow within fixed valve and rotary valve of ceramic materials is separated from other structural members. Thus, water quality is maintained, and the service life of the water diverter is extended.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a water diverter, and more particularly to a water diverter with an innovative water inlet.

2. Description of Related Art Including Information Disclosed Under 37 CFR 1.97 and 37 CFR 1.98.

A water diverter, which differs from a common water control ceramic valve, is used to divert the guided water flow (no temperature limitation) to different outlet paths. The water control ceramic valve is used to control the start/stop and temperature adjustment of water flow (single or dual temperature) with a single water path.

A typical water diverter structure is depicted in FIGS. 1 and 2, wherein water inlet 11 is assembled onto peripheral site 13 of the housing 10 of water diverter, and water outlet 12 is arranged at intervals on the base 14 of the water diverter. So, water flow W flows laterally into the water diverter, and flows out from the bottom of the water diverter (shown in FIG. 1).

However, there are shortcomings observed during actual applications. Referring to FIG. 1, when water flow W flows into water diverter from water inlet 11 of peripheral site 13, it passes through the housing 10 and then flows out from water outlet 12 of the base 14. Given the fact that the housing 10 is full of water, the metal shaft lever 15 of the water diverter is vulnerable to erosion and damage along with water contamination. Additionally, the housing 10 is generally made of plastic. If water in the water flow W is hot, the housing 10 will be degraded quickly, leading to a shorter service life.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

The enhanced efficacy of the present invention is as follows:

Referring to FIGS. 4 and 5, the water inlet 80 is placed centrally onto the fixed valve 60 and base 70, so that one end of the through-flow slot 51 of rotary valve 50 is normally linked to the water inlet 80. The other end is adapted to different water outlets 90A, 90B, 90C depending upon the rotation angle of the rotary valve 50. In such a case, water flow W1 within fixed valve 60 and rotary valve 50 of ceramic materials is separated from the housing 20 and other structural members, so the service life of the water diverter could be further extended. Water quality could be maintained reliably by preventing the water flow from contact with other materials (e.g. brake axle 30 is generally made of pig metals).

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an assembled sectional view of a prior art water diverter.

FIG. 2 shows a schematic view of a prior art water diverter.

FIG. 3 shows an assembled perspective view of a water diverter of the present invention.

FIG. 4 shows an exploded perspective view of the water diverter of the present invention.

FIG. 5 shows an assembled sectional view of the water diverter of the present invention.

FIG. 6 shows a schematic view of the water diverter of the present invention.

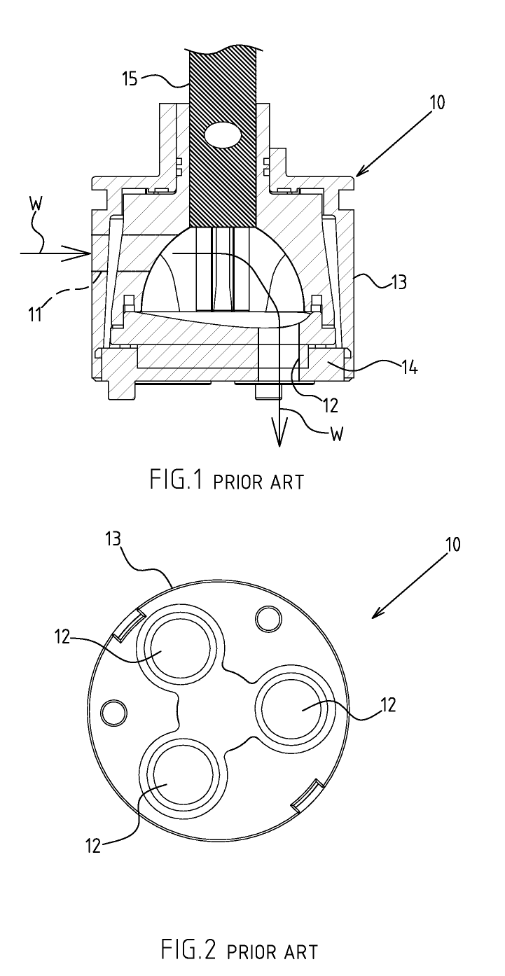

### DETAILED DESCRIPTION OF THE INVENTION

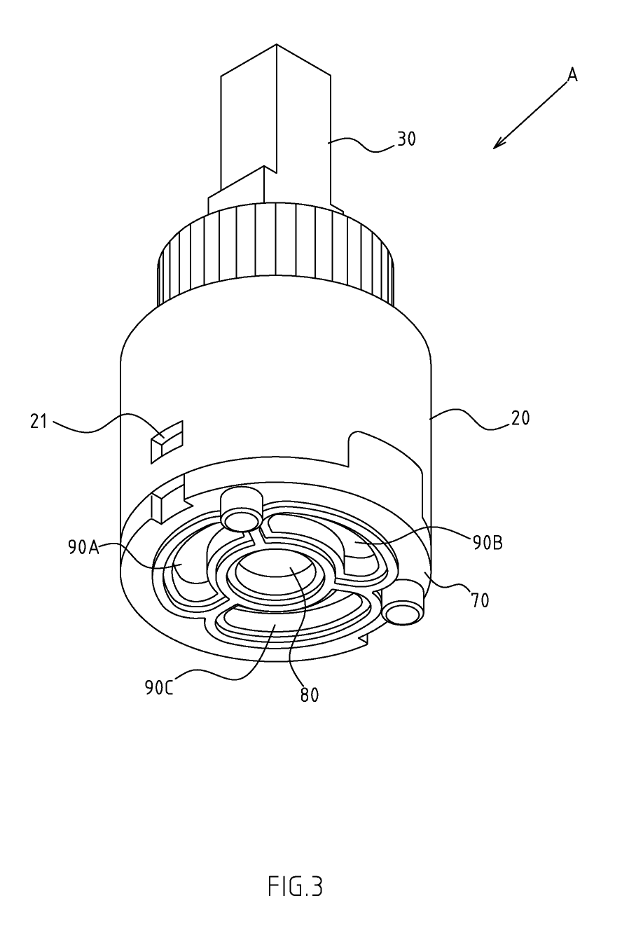

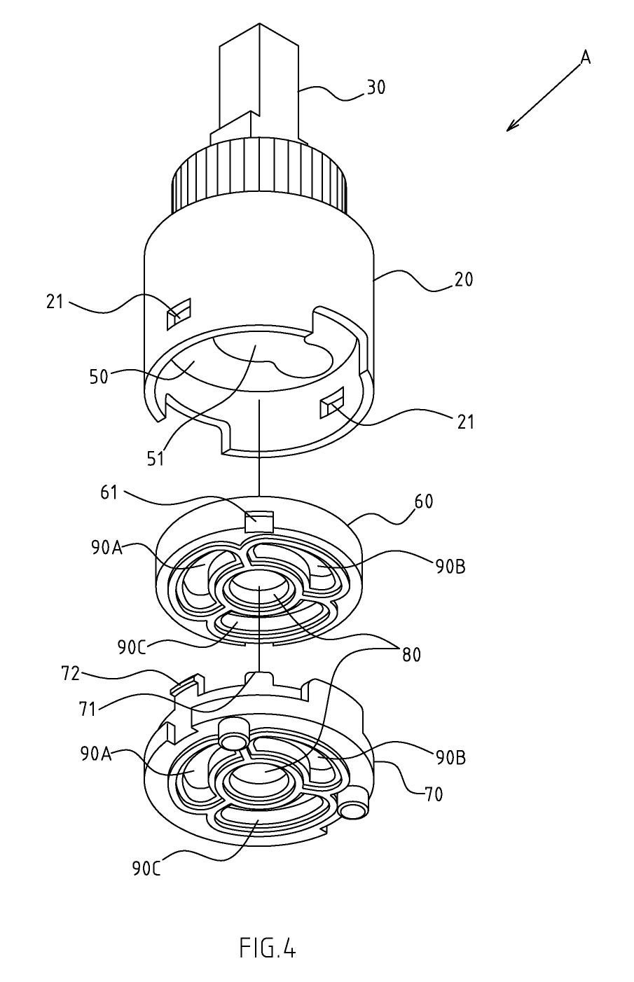

FIGS. 3-6 depict preferred embodiments of improved water diverter of the present invention. The embodiments are provided only for explanatory purposes. The scope of the invention is set by the patent claims.

Said water diverter A comprises a housing 20, a brake axle 30, a drive seat 40, a rotary valve 50, a fixed valve 60, a base 70, a water inlet 80 and water outlets 90A, 90B, 90C. The rotary valve 50 rotates by coupling the brake axle 30 and drive seat 40.

Assembly holes 21 are placed opposite around the housing 20, so that the assembly portion 72 on the base 70 is positioned securely. Grooves 61 are placed symmetrically around the fixed valve 60, so that the flange portion 71 on the base 70 is adapted, making it possible to fasten the base 70 and fixed valve 60.

Said water outlets 90A, 90B, 90C are arranged at intervals through the fixed valve 60 and base 70, while the rotary valve 50 is provided with a through-flow slot 51 for linking a water inlet and outlets. The water inlet 80 is placed centrally onto the fixed valve 60 and base 70, so that one end of the through-flow slot 51 of rotary valve 50 is normally linked to the water inlet 80, and the other end is adapted to different water outlets 90A or 90B or 90C depending upon the rotation angle of the rotary valve 50.

Said water inlet 80 is a round hole, so that water outlets 90A, 90B, 90C are arranged externally onto the water inlet 80 in a curved manner.

The rotary valve 50 and fixed valve 60 are made of ceramic materials.

Based upon above-specified structures, the present invention is operated below:

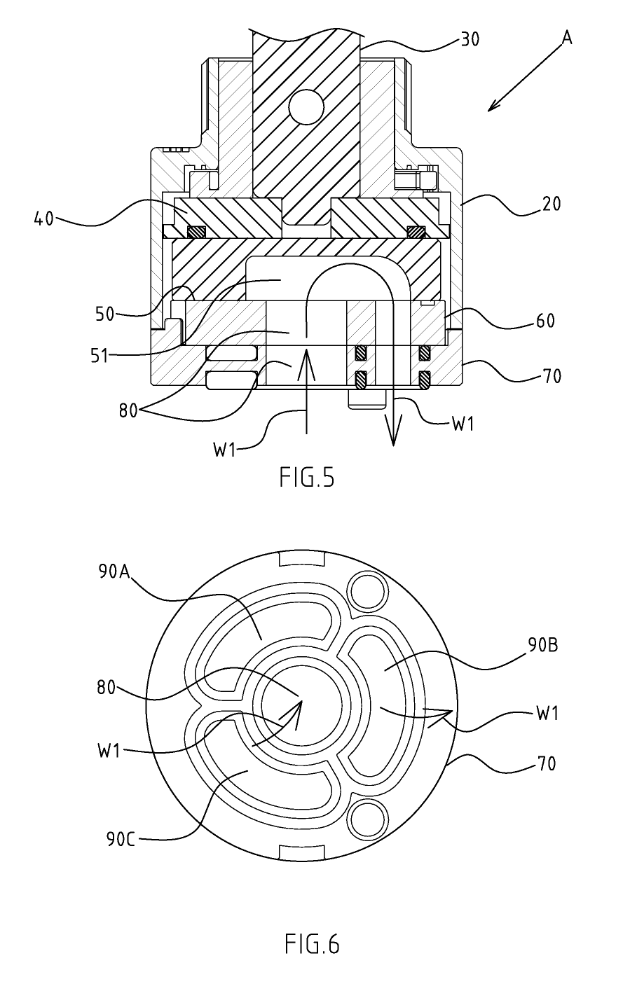

Referring to FIGS. 5 and 6, the water inlet 80 of said water diverter A is assembled onto the preset water inlet end (e.g. a tank for faucet body), and the brake axle 30 is linked to a revolving seat (e.g. common seat of faucet, a round seat or a seat with handle). When the revolving seat is rotated, original path of water flow W1 could be changed, so that said water diverter A may discharge water from the user-adjusted water outlets 90A, 90B, 90C (as shown in FIG. 6, water flow W1 is discharged from water outlet 90A via through-flow slot 51, but may be discharged from water outlet 90B after adjustment).

1. A water diverter, comprising;
a housing;
a brake axle;
a drive seat;
a rotary valve being rotated by coupling said brake axle and said drive seat;
a fixed valve;
a base;
a water inlet; and
at least two water outlets, said at least two water outlets being arranged at intervals through said fixed valve and said base, said rotary valve having a through-flow slot linking said water inlet and the water outlets;
said water inlet being placed centrally onto said fixed valve and said base, said through-flow slot having one end linked to said water inlet and another end adapted to the water outlets depending upon rotation angle of said rotary valve.

2. The water diverter defined in claim 1, wherein said water inlet is a round hole, the water outlets being arranged externally onto said water inlet in a curved manner.
